(19) United States
(12) Patent Application Publication
(10) Pub. No.: US 2007/0146357 A1
(43) Pub. Date: Jun. 28, 2007

(54) Light guide and display device incorporating the same

(75) Inventor: Chien-Chiang Hsu, Taoyuan City (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/606,003

(22) Filed: Nov. 30, 2006

(30) Foreign Application Priority Data
Dec. 28, 2005 (TW) 94147025

(51) Int. Cl. G09G 5/00

(52) U.S. Cl. 345/207

(57) ABSTRACT

A light guide and a display device incorporating the same are provided. The light guide includes a first surface, a second surface and a lateral surface. The first surface is for receiving a light beam. The second surface is for guiding the light beam and is opposite to the first surface. The second surface has an irregular structure for reducing a luminous flux of a total reflection of the light beam projected on the second surface. The lateral surface is for connecting the edges of the first surface and the second surface. Meanwhile, the luminous flux of the light beam from the first surface to the second surface is larger than the luminous flux of the light beam from the first surface to the lateral surface.

This application claims the benefit of Taiwan application Serial No. 9414702, filed Dec. 28, 2005, the subject matter of which is incorporated herein by reference.

### BACKGROUND OF THE INVENTION

1. Field of the Invention

The invention relates in general to a light guide and a display device incorporating the same, and more particularly to a light guide and a display device incorporating the same with restriction on size ratio and an irregularly structured surface.

2. Description of the Related Art

The display brightness of the frame of an ordinary display device such as liquid crystal TV can be manually adjusted by the user to fit into the environmental brightness. For example, when watching the TV at a dark room or in the night time, the viewer might feel that the screen brightness is too Bright. To the contrary, when watching the TV at a well-illuminated room or in the day time, the viewer might feel that the screen brightness is too dark. Apart from the conventional design of disposing the buttons on the display device or the remote controller, an alternative design of disposing a light sensor on the housing of the display device to detect environmental brightness so as to adjust screen brightness is also available.

Due to esthetic consideration, the light sensor is normally disposed inside the housing, and the external light is guided to the light sensor by a light pipe. Normally, the light pipe has a receiving end and an output end. The light pipe receives the light from the receiving end, and then the received light is guided to the output end by the total reflection of the wall of the light pipe first, and outputted to the light sensor from the output end next.

However, for an ordinary light pipe made from a transparent material, when the light is projected onto the cross-section of the receiving end, the incident angle degrees is restricted to be within ±30˜42 degrees. Otherwise, when the light beam is projected onto the wall of the light pipe, the incident angle is unable to achieve the critical angle above which total reflection occurs and part of the light beam will be refracted from the light pipe, resulting in a light loss at the output end and affecting the guiding effect. Thus, the disposition of the cross-section of the receiving end on the housing is largely affected. For example, the light pipe must be disposed at the top of the housing for receiving the light generated by the light source disposed at Top indoors.

It can be seen from the above disclosure that the disposition of the display device is restricted. For example, the display device can not be too far away from the underneath of the light source, and the display device can not be embedded into the wall lest the light pipe disposed at the top of the housing might be shielded despite a liquid crystal TV is getting thinner and lighter and can be hanged on the wall as a part of interior decoration.

### SUMMARY OF THE INVENTION

It is therefore an object of the invention to provide a light guide and display device incorporating the same. Through restrictions on size ratio and the surface design of an irregular structure, the light guide assures the guiding effect of the light even when the incident angle of a light beam is large. With a simple structure, the flexibility of the disposition of the light guide on the display device is increased, and the manufacturing cost is reduced.

The invention achieves the above-identified object by providing a light guide. The light guide includes a first surface, a second surface and a lateral surface. The first surface is for receiving a light beam. The second surface is for guiding the light beam and is opposite to the first surface. The second surface has an irregular structure for reducing a luminous flux of a total reflection of the light beam projected on the second surface. The lateral surface is for connecting the edges of the first surface and the second surface. Meanwhile, the luminous flux of the light beam from the first surface to the second surface is larger than the luminous flux of the light beam from the first surface to the lateral surface.

The invention further achieves the above-identified object by providing a display device. The display device includes a housing, a screen, a light guide, a light sensor and a controlling circuit. The screen is disposed on the front surface of the housing. The light guide is used for guiding a light beam. The light guide includes a first surface, a second surface and a lateral surface. The first surface is for receiving the light beam. The first surface is disposed on the front surface of the housing. The second surface is for guiding the light beam and is opposite to the first surface. The second surface has an irregular structure for reducing a luminous flux of a total reflection of the light beam projected on the second surface. The lateral surface is for connecting the edges of the first surface and the second surface, meanwhile the luminous flux of the light beam from the first surface to the second surface is larger than the luminous flux of the light beam reflected from the first surface and projected onto the lateral surface. The light sensor disposed inside the housing and opposite to the second surface is for receiving a light beam guided by the second surface and outputting a signal accordingly. The controlling circuit couples the screen and the light sensor, and adjusts the screen brightness according to the signal.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram of a display device adjusting screen brightness by environmental brightness according to a preferred embodiment of the invention;

FIG. 2A is a top view of the structure of a light guide according to a preferred embodiment of the invention;

FIG. 2B is a cross-sectional view of the structure of the light guide viewed along the cross-sectional line 2b-2b′ of FIG. 2A; and

FIG. 3 is a diagram of the light guide guiding a light beam according to a preferred embodiment of the invention.

### DETAILED DESCRIPTION OF THE INVENTION

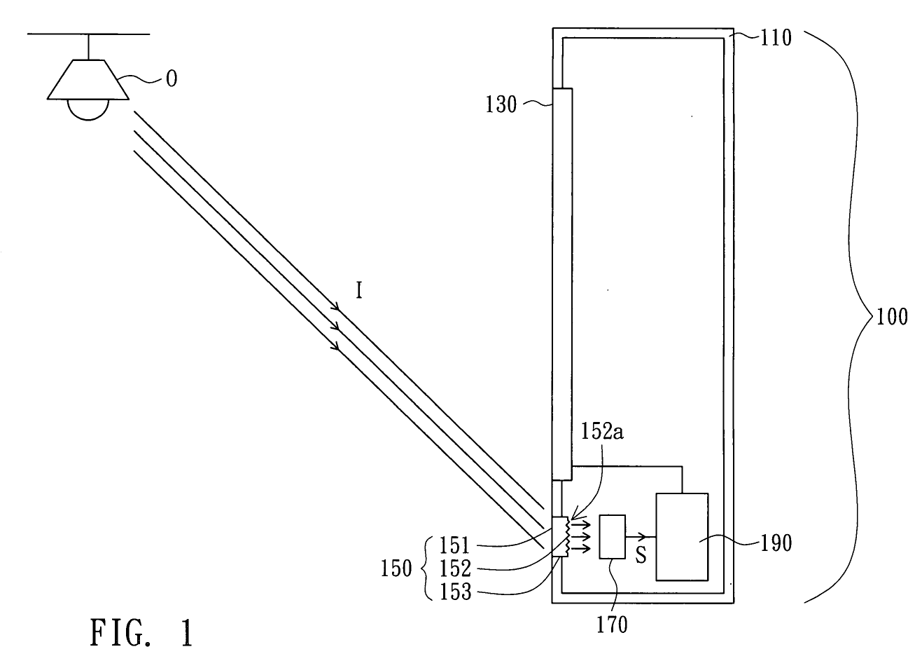

Referring to FIG. 1, a diagram of a display device adjusting screen brightness by environmental brightness according to a preferred embodiment of the invention is shown. The display device 100, such as a liquid crystal TV or a plasma TV, includes a housing 110, a screen 130, a light guide 150, a light sensor 170 and a controlling circuit 190. The screen 130 is disposed on the front surface of the housing 110. The light guide 150 can be made from a transparent material, such as poly methyl methacrylate (PMMA), MS resin, poly carbonate (PC) and polyethylene terephthalate (PET) and so on. The light guide 150 is for receiving and guiding a light beam l emitted by a light source O. The light guide 150 includes a first surface 151, a second surface 152 and a lateral surface 153.

The first surface 151 used for receiving the light beam l is disposed on the front surface of the housing 110. The second surface 152 used for guiding the light beam l is opposite to the first surface 151. The second surface 152 has an irregular structure 152a for reducing a luminous flux of a total reflection of the light beam l projected on the second surface 152. Examples of the irregular structure 152a include a texture structure. The lateral surface 153 is for connecting the edges of the first surface 151 and the second surface 152. Meanwhile, a luminous flux of the light beam l from the first surface 151 to the second surface 152 is larger than a luminous flux of the light beam l from the first surface 151 to the lateral surface 153. Examples of the light sensor 170 include a charge couple device (CCD), a complementary metal-oxide semiconductor (CMOS) or a light sensor capable of sensing the brightness of the light. The light sensor 170 is disposed inside the housing 110 and opposite to the second surface 152 for receiving a light beam l guided by the second surface 152 and then outputting a signal S accordingly. The controlling circuit 190 couples the screen 130 and the light sensor 150, and adjusts the brightness of the screen 130 according to the signal S.

The light guide 150 is substantially a column. The first surface 151 and the second surface 152 substantially have the same shape. The first surface 151 is a circle or a polygon. In the present embodiment of the invention, the first surface 151 is exemplified by a circle. As for how the light guide 150 enables the luminous flux of the light beam l from the first surface 151 to the second surface 152 to be larger than the luminous flux of the light beam l from the first surface 151 to the lateral surface 153 through restrictions on size ratio and how the light beam l is guided to the light sensor 170 are disclosed below. However, the technology of the invention is not limited thereto.

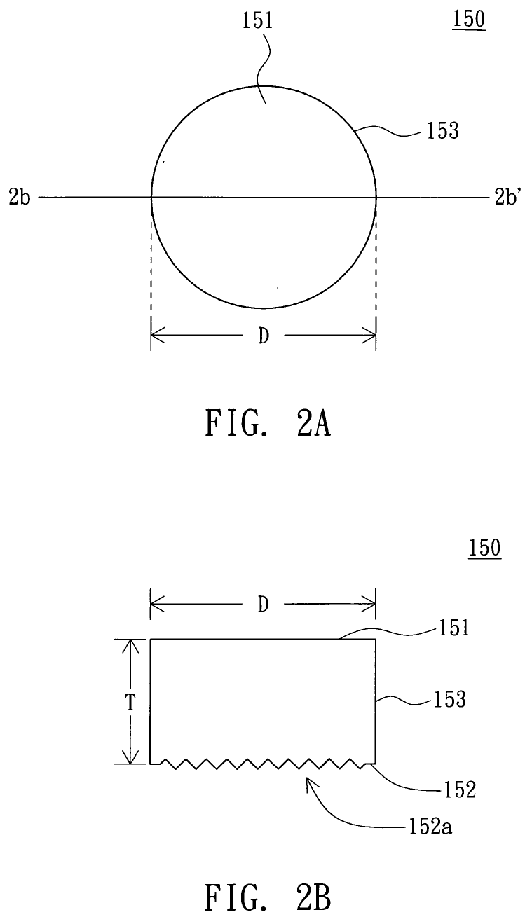

Referring to FIGS. 2A˜2B. FIG. 2A is a top view of the structure of a light guide according to a preferred embodiment of the invention. FIG. 2B is a cross-sectional view of the structure of the light guide viewed along the cross-sectional line 2b-2b′ of FIG. 2A. In FIG. 2A, the drawing and reference number of the second surface 152 are omitted, and the cross-sectional line 2b-2b′ passes through the centric point of the first surface 151. According to the invention, the diameter D of a inscribed circle of the first surface 151 is substantially larger than N times of a relative distance T between the first surface 151 and the second surface 152, wherein N is larger than 1. When the first surface 151 is a circle as shown in FIG. 2A, the inscribed circle diameter D is the diameter of the first surface 151. In the present embodiment of the invention, N is preferably equal to 1.72.

Through the restriction of N, after the light beam l enters the light guide 150, the luminous flux refracted from the first surface 151 and projected directly onto the second surface 152 is larger than that according to the conventional light pipe. That is, compared with the conventional light pipe, despite the light beam l enters the light guide 150 from the first surface 151 at a larger incident angle, such as an incident angle larger than 42 degrees, the luminous flux projected onto the lateral surface 153 is less than that according to the conventional light pipe, hence the light loss refracted from the light guide 150 through the lateral surface 153 is reduced according to the invention. Besides, after the light beam l enters the light guide 150 through the first surface 151 at a larger incident angle first and then projected onto the second surface 152 next, the incident angle onto the second surface 152 may achieve the critical angle of total reflection. Meanwhile, the irregular structure 152a of the second surface 152, which changes the angles at different parts of the second surface 152, increases the luminous flux of the light beam l refracted from the second surface 152 so as to achieve the guiding effect of the light

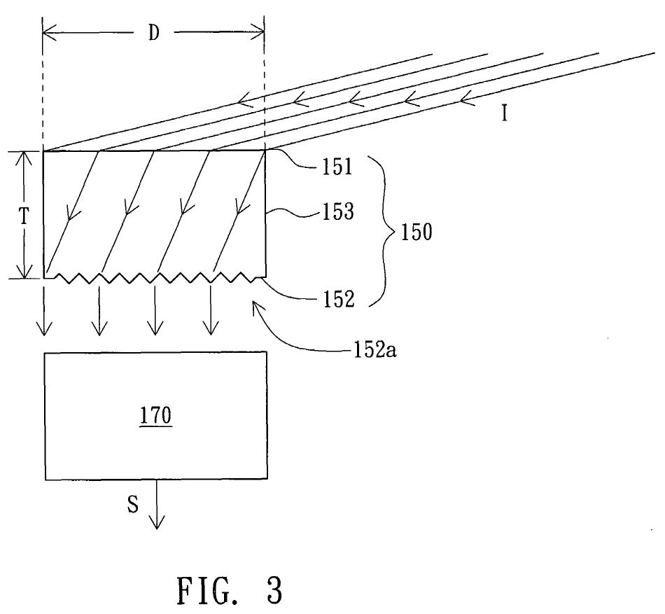

Referring to FIG. 3, a diagram of the light guide guiding a light beam according to a preferred embodiment of the invention is shown. For example, the light guide 150 is normally made from glass, and the diameter D of the first surface 151 is 5.5 unit length, and the relative distance T between the first surface 151 and the second surface 152 is 3.17 unit length. Meanwhile, despite the light beam l enters the light guide 150 through the first surface 151 at an incident angle of 89 degrees first and emits via the second surface 152 next, the guided luminous flux is still over 50% of the luminous flux of the light beam l when projected onto the first surface 151. Therefore, the light sensor 170 receives sufficient brightness to correctly output a signal S, whereby the controlling circuit 190 appropriately adjusts the brightness of the screen 130.

Despite the light guide 150 of the present embodiment of the invention is exemplified by being disposed inside the display device 100, however, the light guide 150 of the present embodiment of the invention is also applicable to any electronic device which controls the internal circuit according to the feedback of external brightness. Any one who is skilled in the technology of the invention will understand that when the light guide 150 adopts various polygons such as an equal polygon or is made from materials of various refraction indices, the desired guiding effect still can be achieved by adjusting the overall size of the light guide 150 under the given relationship of the ratio between the inscribed circle diameter D and the relative distance T

According to the light guide and display device incorporating the same disclosed in the above embodiment of the invention, through the design of the irregular structure on the second surface and the ratio relationship of the inscribed circle diameter of the first surface and the relative distance between the the first surface and the second surface, not only the light sensor is enabled to sense sufficient brightness, but also the problem of light loss, which occurs to the conventional light pipe when the light is projected at a larger incident angle, is resolved. Thus, the flexibility in the disposition of the light guide on the housing of the display device as well as the disposition of the display device in the indoor space increases. Moreover, the overall size of the light guide can be adjusted to fit the needs. For example, the relative distance between the first surface and the second surface can be reduced to meet the market demand of the slim, compact and light-weighted features of the display device. Meanwhile, the simplicity in structure is conducive to the reduction in manufacturing cost.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light guide, comprising:
a first surface for receiving a light beam;
a second surface for guiding the light beam, wherein the second surface is opposite to the first surface and has an irregular structure for reducing a luminous flux of a total reflection of the light beam projected on the second surface; and
a lateral surface for connecting the edges of the first surface and the second surface, wherein the luminous flux of the light beam from the first surface to the second surface is larger than the luminous flux of the light beam from the first surface and to the lateral surface.

2. The light guide according to claim 1, wherein the light guide is substantially a column, the first surface and the second surface substantially have the same shape, and the first surface is a circle or a polygon.

3. The light guide according to claim 2, wherein the diameter of a inscribed circle of the first surface is substantially larger than N times of a relative distance between the first surface and the second surface, N is larger than 1.

4. The light guide according to claim 3, wherein N is preferably equal to 1.72.

5. The light guide according to claim 1, wherein the irregular structure is a texture structure.

6. The light guide according to claim 1, wherein the light guide is made from a transparent material.

7. a display device, comprising:
a housing;
a screen disposed on the front surface of the housing;
a light guide for guiding a light beam, the light guide comprising:
a first surface for receiving the light beam, wherein the first surface is disposed on the front surface of the housing;
a second surface for guiding the light beam, wherein the second surface is opposite to the first surface and has an irregular structure for reducing a luminous flux of a total reflection of the light beam projected on the second surface; and
a lateral surface for connecting the edges of the first surface and the second surface, wherein the luminous flux of the light beam from the first surface to the second surface is larger than the luminous flux of the light beam from the first surface to the lateral surface;
a light sensor disposed in the housing and opposite to the second surface, wherein the light sensor is for receiving the light beam guided by the second surface and outputting a signal accordingly; and
a controlling circuit for coupling the screen and the light sensor and adjusting the screen brightness according to the signal.

8. The display device according to claim 7, wherein the light guide is a column, the first surface and the second surface substantially have the same shape, and the first surface is a circle or a polygon.

9. The display device according to claim 8, wherein the diameter of a inscribed circle of the first surface is substantially larger than N times of a relative distance between the first surface and the second surface, N is larger than 1.

10. The display device according to claim 9, wherein N is preferably equal to 1.72.

11. The display device according to claim 7, wherein the irregular structure is a texture structure.

12. The display device according to claim 7, wherein the light guide is made from a transparent material.

13. The display device according to claim 7, wherein the light sensor is a charge couple device (CCD) or a complementary metal-oxide semiconductor (CMOS).

14. The display device according to claim 7, wherein the display device is a liquid crystal TV or a plasma TV.
